(19) United States
(12) Patent Application Publication
(10) Pub. No.: US 2019/0193998 A1
(43) Pub. Date: Jun. 27, 2019

(54) OPERATING METHOD FOR A CRANE INSTALLATION, IN PARTICULAR FOR A CONTAINER CRANE

(71) Applicant: SIEMENS AKTIENGESELLSCHAFT, München (DE)

(72) Inventors: UWE LADRA, Erlangen (DE); ALOIS RECKTENWALD, Herzogenaurach (DE)

(73) Assignee: SIEMENS AKTIENGESELLSCHAFT, 80333 München (DE)

(21) Appl. No.: 16/331,048

(22) PCT Filed: Aug. 16, 2017
(86) PCT No.: PCT/EP2017/070771

§ 371 Date: Mar. 6, 2019

(30) Foreign Application Priority Data
Sep. 7, 2016 (EP) 16187545.5

(51) Int. Cl. B66C 13/30; B66C 19/00; B66C 13/06

(52) U.S. Cl. CPC B66C 13/30; B66C 13/063; B66C 19/002

(57) ABSTRACT

A crane installation, in particular a container crane, has a trolley for transporting a load. The load to be transported determines loading of the trolley. The crane installation has a travel drive connected to the trolley and a trolley controller connected to the travel drive for controlling travel movements of the trolley. The trolley controller controls acceleration operations and braking operations during the travel movement of the trolley as a function of the loading of the trolley and the maximum available drive force of the travel drive. At least one acceleration operation has two sections with positive acceleration values of equal magnitude and an intermediate section with negative acceleration values of the same magnitude, and at least one braking operation has two sections with negative acceleration values of equal magnitude and an intermediate section with positive acceleration values of the same magnitude.

The present invention relates to an operating method for a crane installation, in particular for a container crane, with a trolley for transporting a load, wherein the load to be transported determines a loading of the trolley, a travel drive connected to the trolley and a trolley controller connected to the travel drive for controlling travel movements of the trolley.

The present invention furthermore relates to a computer program comprising machine code which is directly executable by a trolley controller, wherein the execution of the machine code by the trolley controller causes the trolley controller to control travel movement of the trolley.

As is known, crane installations serve the transshipment of cargo, wherein container crane installations in particular serve the movement or transportation of large containers, which are between 20 feet and 48 feet long, for example. Typical sizes are 20 feet, 40 feet and 48 feet. A foot corresponds to 12 inches and thus 30.48 cm. Container crane installations are used for example for loading and unloading ships or railway cars etc. A crane installation of this kind generally has a trolley which can travel horizontally, from which a load carrying device, i.e. a container spreader for example, is suspended, via which the load to be moved is gripped. The container transshipment takes place primarily via the trolley movement.

The loading and unloading of the container ships takes place in manned container bridges by way of a crane driver, who sits in a cabin which is generally attached to the trolley. In manned container bridges, accelerations and also changes to the acceleration (i.e. the jerk) during the container transshipment are limited, so that the accompanying crane driver is not under non-permissible physical stress due to acceleration forces occurring in the process and is not negatively affected in terms of his wellbeing.

In manned container bridges, the travel drive of the trolley is therefore designed for a defined acceleration (for example 0.6 m/s²) at a maximum loading or maximum load to be transported. Maximum loading means a total mass which has to be moved in the range of 110 t, for example. In this case, this total mass is composed of the following, for example:

| | | |
|---|---|---|
| Mass of the trolley: | approx. | 25-30 t |
| Mass of the headblock: | approx. | 5-10 t |
| Mass of the spreader: | approx. | 10-15 t |
| Max. container mass, | | |
| two 20-foot containers, fully loaded: | approx. | 60 t |

Accelerations and braking operations during the travel movements of the trolley thus take place at the acceleration of e.g. 0.6 m/s², which is defined once. This also applies when a loading which is lower than the maximum is to be transshipped.

New container bridges are more and more frequently being equipped without a crane driver cabin and are operated automatically. For picking up and setting down the load at the target position, the container bridges are generally controlled via a remote control desk. This enables an automatic operation of the container bridges. The target positions for loading and unloading to be approached are communicated to the crane controller via shipping orders.

The object of the present invention consists in specifying an operating method for a crane installation, whereby in particular in automatic crane operation a cargo transshipment is possible which is faster compared to previously known operating methods.

The object is achieved by means of an operating method having the features of claim 1. Advantageous embodiments of the operating method form the subject matter of the dependent claims 2 to 10.

According to the invention, the operating method specified in the introduction is embodied such that the trolley controller controls acceleration and braking operations during the travel movement of the trolley as a function of the loading of the trolley and the maximum drive force available. This leads to motion characteristics which are optimal in terms of time, because during all acceleration and braking operations the maximum drive force of the travel drive can be used at all times in the motion characteristics.

This operating method leads to a time-optimized cargo transshipment, in particular in an automatic operation of the crane installation. The invention is based on the recognition that the masses to be moved may change considerably during the individual travel procedures. For example, one container may have a mass of 25 t, while another container may have a mass of 10 t. In addition, there are also what are known as empty runs, i.e., runs without container on the load carrying device. Therefore, other prerequisites for a time-optimized container transshipment apply for the automatic operation than for the semi-automatic operation with an accompanying crane driver, where the resulting high acceleration values with a reduced load would not be possible due to the limited physical resilience of the crane driver.

The arising differences in mass on the one hand result from the variation in freight in the containers, but also on the other hand from different types and sizes of container, meaning that the empty masses alone may already differ from container to container.

Moreover, different types of spreader, which also vary in their spreader mass, make it possible to transport a different number of containers with different designs and sizes. A large variety of container transport options is therefore possible, whereby a different mass is constantly being transported in each case.

The masses remaining constant are the mass of the trolley itself and the mass of the headblock. Everything else may vary.

An example intends to illustrate the time saving made possible by the invention. When unloading a container ship, e.g. a double container is brought from ship to land. For logistical reasons, no container is usually transported on the return path to the ship. During this so-called empty run, the mass to be moved of the headblock plus spreader amounts to 20 t, for example. Together with the trolley, the total mass then amounts to 50 t for example, which represents approximately half of the maximum loading of 110 t. Accordingly, it would be possible to travel at just over twice the acceleration if use were made of the available drive force during this empty run. When transporting only a 20-foot container from ship to land, there would be approx. 25% less total mass, meaning that in this case it would be possible to travel with 25% more acceleration than at maximum loading.

As the trend is increasingly towards rope-drawn trolleys, there is also no obstacle to an increase in trolley acceleration, as in such a travel drive there Is fundamentally no limitation to the acceleration due to the wheel-rail friction.

An advantageous embodiment of the operating method is given by the features of claim 2, according to which the loading of the trolley is acquired by a load measuring device connected to the trolley and the load. With this, the trolley controller has access to the current loading directly and at any time, for specifying and controlling the travel movement.

A particularly advantageous embodiment of the operating method is given by the features of claim 6, according to which the trolley controller controls the travel movement such that oscillations of the load are compensated when reaching a target position. With this, the time required for the cargo transshipment is reduced further, as waiting times due to swinging do not apply. An oscillation regulation for subduing the oscillating movement therefore only has to correct disturbances, such as the wind pressure for example. This means that a considerably faster positioning is possible compared to conventional operation. In conventional operation, the oscillation regulation is active during the entire travel path. There is no separation of reference and disturbance behaviors in conventional operation, meaning that it is also able to compensate oscillation movements during manual intervention on the travel speed by the crane driver (changes to the reference variables).

A further particularly advantageous embodiment of the operating method is given by the features of claim 8, according to which the travel drive comprises at least one electric motor, and during the travel movement the at least one electric motor is operated at at least two different operating points. This means that, with the aim of as high a travel speed as possible, a cascading of a plurality of different time-optimized motion characteristics is possible, in particular with long travel paths. During accelerations, the motor is operated at its first operating point until it attains a first maximum speed. The motor is then operated at a second operating point, which is characterized by a second maximum speed. The second maximum speed is higher than the first maximum speed. This increased maximum speed is then used in the constant travel region. With very long travel paths, a multiple cascading of a plurality of operating points is possible, wherein the operating points differ by higher rotational speeds with a lower torque in each case.

The object is also achieved by a computer program having the features of claim 11. According to the invention, a computer program is embodied such that the execution of the machine code thereof by the trolley controller causes the trolley controller to receive a loading of a trolley controlled by the trolley controller and control acceleration and braking operations during the travel movement of the trolley as a function of the loading of the trolley and the maximum available drive force of the travel drive.

The properties, features and advantages of this invention described above as well as the manner in which they are achieved will become clearer and more comprehensible in conjunction with the following description of the exemplary embodiments, which are explained in more detail in conjunction with the drawings, in which, in a schematic representation:

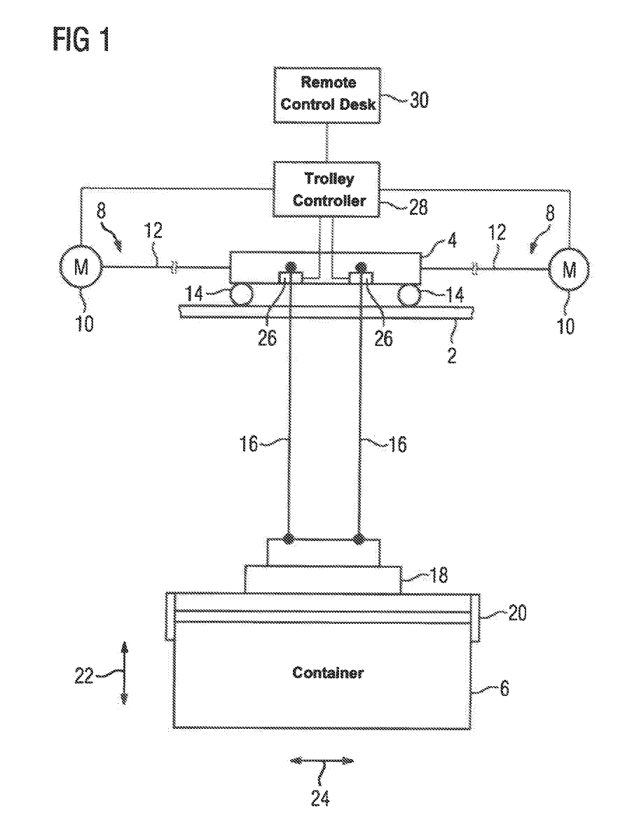

FIG. 1 shows an overview representation of a cutout of a container crane installation with a traveling trolley and an associated trolley controller,

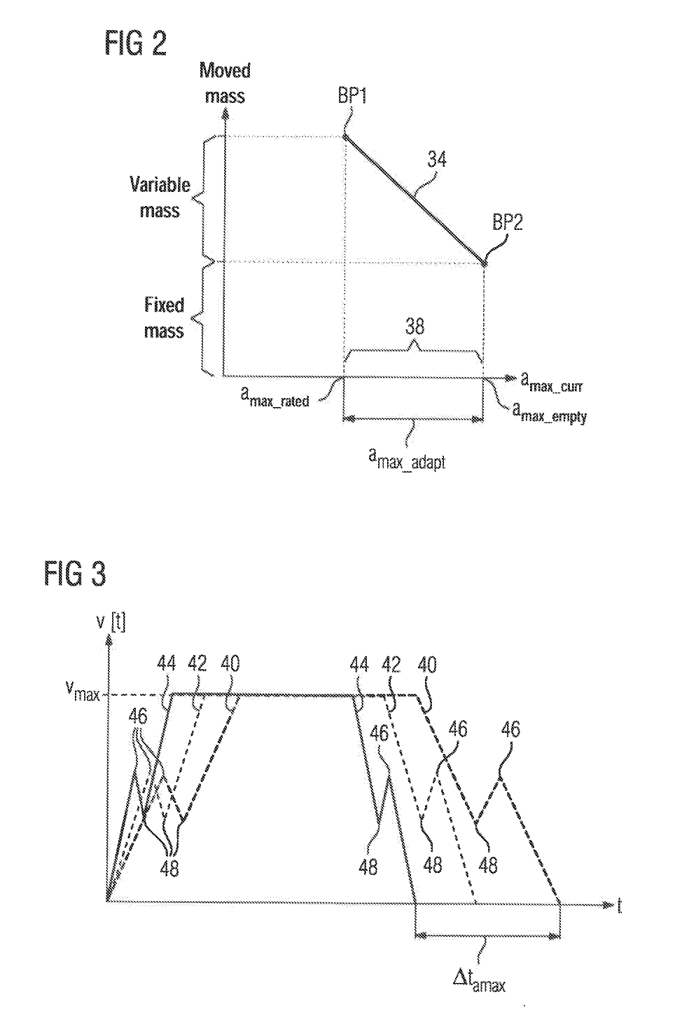

FIG. 2 shows a diagram of the dependency of the load-dependent maximum acceleration of the moved mass,

FIG. 3 shows a time-related diagram of different speed profiles at different loading,

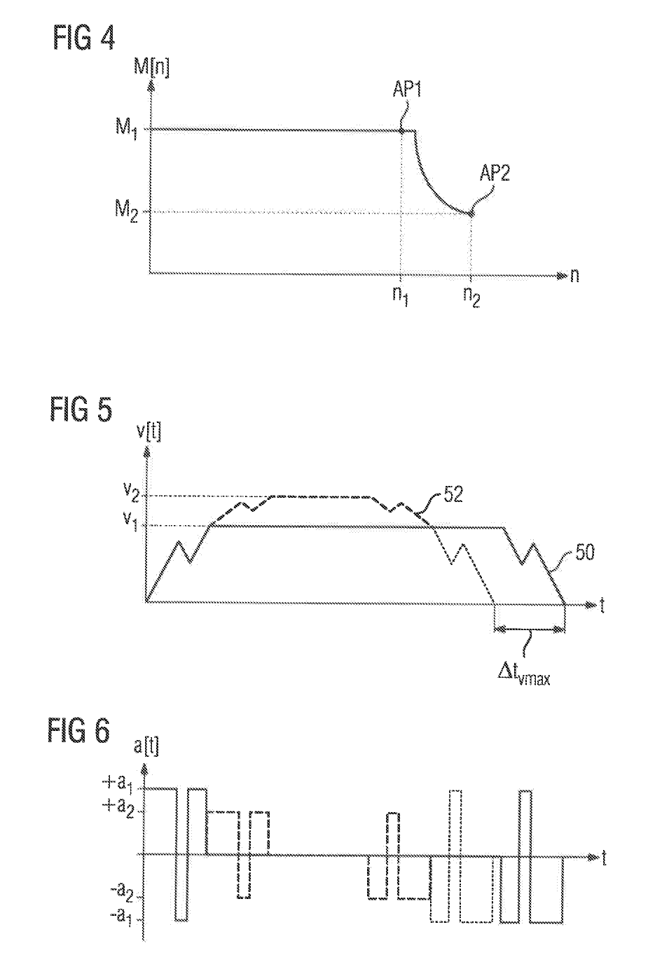

FIG. 4 shows a diagram of a motor characteristic of an electric motor with two different operating points,

FIG. 5 shows a speed profile of a travel movement with an electric motor, which is operated at two different operating points during the travel movement, and

FIG. 6 shows the acceleration values associated with the speed profile as in FIG. 5.

FIG. 1 shows a cutout of a container crane installation, as is used for example for loading and unloading a ship located at a dock, with a horizontally oriented jib 2. Guided on the jib 2 is a traveling trolley 4—subsequently only referred to as trolley 4—for transshipment of a load. The load may be present in the form of one or even two container 6, for example. The trolley 4 is connected to a travel drive 8. This is preferably a rope-guided travel drive 8 with two electric motors 10. The two electric motors 10 are, for example, mechanically connected to the trolley 4 via a rope drive 12 such that they are opposing in the direction of movement. The trolley 4 runs on the jib 2 on rollers or wheels 14. Rope-guided travel drives 8 permit high acceleration values, which are not limited by a friction value between the roller 14 and a rail guidance of the jib 2.

Arranged in the trolley 4 is a hoisting gear (not shown here) for raising and lowering the load 6 to be transported. The hoisting gear comprises hoist rope 16, which is fastened at its ends to a headblock 18. The headblock 18 connects a spreader 20 to the hoisting gear. The spreader 20 grasps the load 6 for transportation.

The trolley 4 thus enables, via the hoisting gear, vertical movements of the load 6 in the direction of the double-ended arrow 22 and, via the electric motors 10, horizontal travel movements of the load 6 in the trolley direction (double-ended arrow 24).

The hoisting gear of the trolley 4 comprises at least one load measuring device 26, in accordance with FIG. 1 two load measuring devices 26. The load measuring devices 26 may be realized by different technologies, such as ring force transducers, load measuring axes, pressure force transducers or even load measuring bolts. In the present exemplary embodiment, the load measuring devices 26 are embodied as ring force transducers, which are arranged on the rope end points of the hoist rope 16. As “measuring washers” they simultaneously serve the load acquisition and act as overload protection.

The load 6 currently to be transported on the travel trolley 4 is acquired via the load measuring devices 26 and is passed on to trolley controller 28. The trolley controller 28 determines control signals for the travel drive 8 from the current load values, as is described in further detail below. The trolley controller 28 is generally embodied as a software-programmable device. Its functionality is determined in this case by a computer program, by which the trolley controller 28 is programmed. The computer program comprises machine code which can be executed by the trolley controller 28. The execution of the machine code by the trolley controller causes the operation of the crane installation explained in more detail below.

The crane installation is equipped for automatic operation, which enables a target specification for the trolley movements. It is therefore not necessary for the trolley 4 to have a crane driver cabin. Instead, the trolley 4 has sensors for acquiring the position of the load 6 to be transported, the measurement signals of which are fed to the trolley controller 28 for automatic controlling of the travel paths of the trolley 4. The picking up and setting down of the load is carried out by a remote control desk 30, which enables the remote control of the trolley movement.

The trolley controller 28 determines from the current value of the load m_{load}_{_}_{curr} a loading factor K_{load} of the crane. The loading factor K_{load} is defined by the relationship of the current loading m_{load}_{_}_{curr} to the maximum possible loading m_{load}_{_}ₘₐₓ of the crane on the basis of the drive design, i.e. the rated loading or rated load. Therefore, expressed as a formula:

K_{load}=m_{load}_{_}_{curr}/m_{load}_{_}ₘₐₓ (1)

The value of the loading factor K_{load} is always less than or equal to “one”.

Associated with the rated load or rated loading of the crane, which is designed as the maximum loading m_{load}_{_}ₘₐₓ, is a maximum acceleration value aₘₐₓ_{_}_{rated}, which is determined by the rated drive force of the travel drive 8, at which changes in speed take place within the travel path of the trolley 4.

The inventive idea substantiated in the trolley controller 28 is now of increasing the acceleration aₘₐₓ_{_}_{rated} to the value aₘₐₓ_{_}_{adept} at a lower loading of the crane than the rated loading m_{load}_{_}ₘₐₓ (K_{load}<1), as permits the rated drive force of the travel drive 8. The factor for increase in acceleration is the reciprocal of the loading factor:

K_{accel}=1/K_{load} (2)

This means that the current maximum possible acceleration at a loading of the crane which is lower than the rated loading increases accordingly:

aₘₐₓ_{_}_{adapt}=aₘₐₓ_{_}_{rated}*K_{accel}=aₘₐₓ_{_}_{rated}/K_{load} (3)

With the modification of the maximum acceleration aₘₐₓ_{_}_{rated} by the loading factor K_{load} or acceleration factor K_{accel}, it is achieved that for each travel operation travel always takes place at the maximum possible acceleration aₘₐₓ_{_}_{adapt} regardless of the load to be transported.

FIG. 2 shows the relationship between the magnitude of the moved mass and the load-dependent acceleration aₘₐₓ_{_}_{curr} described above. Here, the load-dependent acceleration aₘₐₓ_{_}_{curr} is plotted on the x-axis and the magnitude of the moved mass is plotted on the y-axis. The moved mass results from the sum of fixed mass of the trolley 4, headblock 18 with hoist ropes 16 and spreader 20 plus the variable mass, for example in the form of the container 6 to be transported. At the maximum moved mass, the travel drive 8 can bring about the maximum acceleration aₘₐₓ_{_}_{rated}. This operating state BP1 is characterized in the diagram by the upper start of a working line 34. The maximum possible acceleration during an empty run aₘₐₓ_{_}_{empty}, i.e. only the fixed moved mass without a load to be transported, is specified by the operating point BP2 at the lower end point. Between these two operating points BP1 and BP2, it is possible to travel at a higher acceleration aₘₐₓ_{_}_{adapt} according to the magnitude of the reduced load with respect to the maximum load. The higher acceleration aₘₐₓ_{_}_{adapt} lies between the maximum acceleration aₘₐₓ_{_}_{rated} at full loading and the maximum acceleration during an empty run aₘₐₓ_{_}_{empty}, see in the diagram the operating range 38 on the x-axis.

FIG. 3 shows three typical speed profiles 40, 42, 44 of the trolley 4 on a given travel distance, which are simplified by comparison and result at different load states during automatic operation of the crane. On the one hand, this means that the load-dependent maximum possible acceleration aₘₐₓ_{_}_{adapt} already explained above is used for building up speed and for braking and, on the other hand, the load vibration or load oscillation is also taken into consideration in the motion characteristic. The speed profile 40 results during a loading of the crane at maximum loading, the speed profile 42 results at a partial loading of the crane, and the speed profile 44 results during an empty run of the crane 4.

What is typical for all three speed profiles 40, 42, 44 is that following an increase in speed up to a first maximum speed 46 (local maximum), which however is lower than the generally possible maximum speed vₘₐₓ, there follows a reduction in speed up to a local minimum 48, which is again followed by a maximum possible increase in speed at aₘₐₓ up to the maximum possible speed vₘₐₓ. Running symmetrically to this is the speed profile in the braking phase or in the braked section of the travel movement up to the target position. The changes in speed are designed such that the oscillation of the load is settled at least at the target position and preferably also when attaining the maximum speed vₘₐₓ.

The speed profile 40 is also set in conventional crane installations when only a partial loading is present or even when an empty run is performed. By contrast, in the context of the present invention, during a lower loading the acceleration is increased to the extent that the maximum motor drive force is used for acceleration. The application of the present invention therefore results in a time saving compared to a conventional trolley controller at a partial loading, which assumes the variable Δtₐₘₐₓ during an empty run.

As is known, in various electric motors, such as synchronous motors, asynchronous motors. DC motors etc. for example, it is possible to achieve an increase in the rated rotational speed by reducing the magnetic flux in the excitation winding. This operating range is also referred to as the field-weakening range. FIG 4 shows the typical course of a motor characteristic curve M(n), which shows the generated torque M as a function of the rotational speed n, with a first operating point AP1 in normal field operation and a second operating point AP2 in field-weakening operation. At operating point AP1, a moment M₁ is generated at a rotational speed of n₁ and at operating point AP2 a moment M₂ is generated at a rotational speed n₂. At operating point AP2, although the generated torque is reduced, the rotational speed is simultaneously increased.

By using electric motors and the operation thereof in the field-weakening range, it is possible to increase the time saving during the transshipment of cargo even further, in particular with long travel distances of the trolley 4. A typical case of this is shown in FIG. 5. Longer travel distances can then be traveled at a constant, increased speed. With an electromotive travel drive without field-weakening operation or without using the field-weakening operation, it is possible for a speed profile 50 to be realized for example, in which a maximum travel speed v₁ can be attained with the drive moment M₁. A further time saving during the transshipment of cargo can now be achieved if, during approach, when the rated rotational speed n₁ has been attained at operating point AP1, there is a switch to the operating point AP2 of the field-weakening operation. Then, although the drive moment M₂ is reduced, the maximum travel speed v₂ is increased further. In a similar manner, during braking, when the travel speed v₁ has been attained, there is a switch back to the operating point AP1 . This relationship is illustrated by the speed profile 52. Also represented in FIG. 5 is the time saving Δtᵥₘₐₓ which can be achieved by the field-weakening operation.

FIG. 6 shows the acceleration profiles associated with the speed profiles 50 and 52. Owing to the higher drive moment M₁ available during normal operation, an acceleration value of a₁ can be attained. The acceleration value a₂ which can be achieved in field-weakening operation is lower than in normal operation.

In very long travel distances, by way of the further cascading of operating points in field-weakening operation, a further increased end speed and thus a further time saving can be attained during cargo transport.

The present invention has many advantages. In particular, there is a greater transshipment.

Although the invention has been illustrated and described in detail with the preferred exemplary embodiment, the invention is not restricted by the examples disclosed and other variations can be derived therefrom by a person skilled in the art without departing from the protective scope of the invention.

1.-12. (canceled)

13. An operating method for a crane installation, in particular for a container crane, with a trolley for transporting a load, said method comprising:
determining loading of the trolley based on the load to be transported; and
controlling travel movements of the trolley with a travel drive connected to the trolley and a trolley controller connected to the travel drive, wherein the travel movements comprise acceleration operations and braking operations during the travel movements of the trolley as a function of the loading of the trolley and a maximum available drive force of the travel drive,
wherein at least one of the acceleration operations comprises two sections having positive acceleration values of equal magnitude and an intermediate section having a negative acceleration value of a magnitude equal to the magnitude of the positive acceleration values, and
wherein at least one of the braking operations comprises two sections having negative acceleration values of equal magnitude and an intermediate section having a positive acceleration value of a magnitude equal to the magnitude of the negative acceleration values.

14. The method of claim 13, further comprising acquiring the loading of the trolley with a load measuring device connected to the trolley.

15. The method of claim 13, wherein the travel movement of the trolley comprises at least one acceleration section and at least one braking section, and wherein the positive and/or negative acceleration values depend on the loading.

16. The method of claim 13, wherein a maximum acceleration of the travel movement is determined from a maximum drive force of the travel drive and a minimum loading of the trolley.

17. The method of claim 13, further comprising:
determining a maximum acceleration of the travel movement by a maximum drive force of the travel drive and a maximum loading of the trolley; and
increasing the maximum acceleration at a current loading compared to the maximum acceleration at the maximum loading by a factor K_{accel}, wherein K_{accel}=m_{load}_{_}ₘₐₓ/m_{load}_{_}_{curr} with m_{load}_{_}_{curr}<, wherein m_{load}_{_}ₘₐₓ is the maximum loading and m_{load}_{_}_{curr} is the current loading.

18. The method of claim 13, further comprising compensating oscillation of the load when the load reaches a target position.

19. The method of claim 13, further comprising compensating oscillation of the load when the load reaches a maximum travel speed.

20. The method of claim 13, further comprising operating an electric motor of the travel drive at at least two different operating points during the travel movement.

21. The method of claim 20, wherein at least one of the operating points is located in a field-weakening range of the electric motor.

22. The method of claim 21, further comprising after attaining a rated rotational speed, operating the electric motor in the field-weakening range to increase the speed of the travel movement

23. A computer program stored on a machine-readable con-transitory storage medium and comprising machine code, wherein the machine code, when loaded into a memory of a trolley controller and executed by the trolley controller, causes the trolley controller to
receive loading of a trolley controlled by the trolley controller, and
control acceleration operations and braking operations during a travel movement of the trolley as a function of the loading of the trolley and a maximum available drive force of the travel drive,
wherein at least one of the acceleration operations comprises two sections having positive acceleration values of equal magnitude and an intermediate section having a negative acceleration value of a magnitude equal to the magnitude of the positive acceleration values, and
wherein at least one of the braking operations comprises two sections having negative acceleration values of equal magnitude and an intermediate section having a positive acceleration value of a magnitude equal to the magnitude of the negative acceleration values.

24. The computer program of claim 23, wherein the trolley controller further determines a maximum acceleration of the travel movement from a maximum drive force of the travel drive and a minimum loading of the trolley.

25. The computer program of claim 23, wherein the trolley controller further determines a maximum acceleration of the travel movement from a maximum drive force of the travel drive and a maximum loading of the trolley, and increases the maximum acceleration at a current loading compared to the maximum acceleration at the maximum loading by a factor K_{accel}, wherein K_{accel}=m_{load}_{_}ₘₐₓ/m_{load}_{_}_{curr} with m_{load}_{_}_{curr}<, wherein m_{load}_{_}ₘₐₓ is the maximum loading and m_{load}_{_}_{curr} is the current loading.

26. The computer program of claim 23, wherein the trolley controller further compensates oscillations of the load when the load reaches a target position or when the load reaches a maximum travel speed.

27. The computer program of claim 23, wherein the trolley controller further operates an electric motor at at least two different operating points during the travel movement.

28. The computer program of claim 27, wherein the trolley controller further operates the electric motor in a field-weakening range.

29. The computer program of claim 28, wherein the trolley controller operates the electric motor in a field-weakening range after attaining a rated rotational speed in order to increase the speed of the travel movement.
